(19) United States
(12) Patent Application Publication
(10) Pub. No.: US 2006/0275646 A1
(43) Pub. Date: Dec. 7, 2006

(54) Fuel cell, electrode catalyst and electrode for fuel cell

(76) Inventor: Kyu-Jung Kim, Gyeonggi-Do (KR)

Correspondence Address: BIRCH STEWART KOLASCH & BIRCH, PO BOX 747, FALLS CHURCH, VA, 22040-0747, US

(21) Appl. No.: 10/557,738

(22) PCT Filed: May 22, 2003
(86) PCT No.: PCT/KR03/01011

§ 371 Date: Nov. 21, 2005

(51) Int. Cl. H01M 4/90; B01J 23/00

(52) U.S. Cl. 429/40; 502/337

(57) ABSTRACT

A fuel cell includes: a fuel electrode made of a hydrogen storage alloy coated with nickel, an oxygen electrode, and an electrolyte unit interposed between the fuel electrode and the oxygen electrode. The fuel cell can supply stable power even though it is used for a long time.

### TECHNICAL FIELD

The present invention relates to a fuel cell and, more particularly, to a fuel cell using hydrogen storage alloy as an electrode.

### BACKGROUND ART

A fuel cell refers toga battery for directly converting a chemical energy generated according to oxidation of fuel such as hydrogen to an electric energy.

FIG. 1 is a schematic view showing an example of a general fuel cell.

As shown in FIG. 1, the fuel cell includes a fuel electrode (anode) 14 and an oxygen electrode (cathode) 16 with electrolyte interposed therebetween.

In the fuel cell with such a structure, a fuel such as hydrogen is supplied to the fuel electrode 14 through a fuel supply pipe 13 and at the same time oxidant such as oxygen or air is supplied to the oxygen electrode 16 through an oxidant supply pipe 17.

At this time, electrons are discharged with an aid of catalyst and oxidation takes place in the anode pole 14. The electrons generated from the anode 14 are transferred to the cathode 16 by way of a load 18 connected to the anode 14 and the cathode 18.

In the cathode 16, as reduction reaction takes place with the electrons transferred by the aid of the catalyst, the oxidant is reduced.

Positive ions/negative ions are transferred from the anode 14 to the cathode 16 or from the cathode 16 to the anode 14 through the electrolyte 12 interposed between the anode 14 and the cathode 16.

In particular, if hydrogen is used as the fuel, as the fuel cell operates, ionization of hydrogen proceeds to hydrogen ion H⁺ and electron e⁻ in the anode 14, and H⁺ generated in the anode 14 is moved to the cathode 16 through the electrolyte and the electron e⁻ is transferred to an external load 18 through the anode 14.

In the cathode 16, H⁺ transferred through the electrolyte 12 reacts with oxygen in the air, generating water together with heat of reaction, which is expressed as the following reaction formula:
Fuel electrode/anode: H₂(g)→2H⁺+2e⁻
Oxygen electrode/cathode: ½O₂(g)+2H⁺+2e⁻→H₂O(I)
Total reaction formula: H₂(9)+½O₂(g)→H₂O(I)

In the fuel cell, generally, a load is connected to the anode 14 and the cathode 16. When the fuel cell operates, electron e⁻ is continuously generated from the anode 14 and flows to the cathode 16 through the load, that is, as electrons are transferred from the anode 14 to the cathode 16, a current is generated to operate an electric device, etc.

In line with the tendency of high energy density, compact and light weight and long life span, a hydrogen storage alloy such as metal hydride is used as an anode of the fuel cell. In the case of using the hydrogen storage alloy, there is no pollution-causing material such as cadmium, so that pollution can be remarkably reduced.

Generally, the fuel cell is expected to supply stable power for a long time. Material and characteristics of an electrode used as an anode or a cathode strongly affect a life span and output of the fuel cell.

In order to enhance efficiency of the fuel cell and extend a life span, various methods related to the electrode have been proposed, including Japanese Laid Open Publication No. 2002-246039, and PCT Application Laid Open Publication WO 01/68246.

However, the manufacturing method of the fuel cell in the above documents is complicate, and in addition, since catalyst in powder form is not completely attached to a catalyst support member, the catalyst is released from the catalyst support member, causing a problem that an efficiency of the electrode and its life span are shortened.

### DISCLOSURE OF THE INVENTION

Therefore, it is an object of the present invention to provide a fuel cell that is capable of continuously maintaining a stable performance and facilitating coupling between catalyst and a catalyst support member, an electrode catalyst and an electrode for a fuel cell.

To achieve these objects, there is provided a fuel cell including: a fuel electrode made of a hydrogen storage alloy coated with nickel; an oxygen electrode; and an electrolyte unit interposed between the fuel electrode and the oxygen electrode.

To achieve the above objects, there is also provided an electrode catalyst of an electrode of a fuel cell having a fuel electrode, an oxygen electrode, an electrolyte unit installed between the fuel electrode and the oxygen electrode, wherein the electrode catalyst is made of a hydrogen storage alloy of which a surface is coated with nickel.

To achieve the above objects, there is also provided an electrode for a fuel cell fabricated with the above-described electrode catalyst.

### BRIEF DESCRIPTION OF THE DRAWINGS

FIG. 1 is a schematic view showing the construction of an example of a general fuel cell;

FIG. 2 is an enlarged view of an electrode catalyst in accordance with the present invention;

FIG. 3 is an enlarged view showing the catalyst of FIG. 2 after cutting;

FIG. 4 is an enlarged view of FIG. 3;

FIGS. 5A to 5C are graphs showing component of portions 1, 2 and 3 of FIG. 2; and

FIG. 6 is a graph of a current density-voltage relation of a fuel cell using the electrode catalyst in accordance with the present invention and its comparative example.

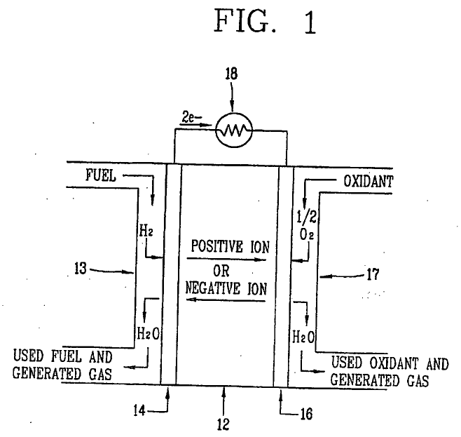

### MODES FOR CARRYING OUT THE PREFERRED EMBODIMENTS

A fuel cell, an electrode catalyst and an electrode for a fuel cell in accordance with the present invention will now be described in detail with reference to the accompanying drawings.

The fuel cell of the present invention includes a fuel electrode (anode) and an oxygen electrode (cathode), an electrolyte between the fuel electrode (anode) and the oxygen electrode (cathode).

The electrode forming the anode or the cathode includes a catalyst for promoting an oxidation reaction of a fuel such as hydrogen and a reduction reaction of an oxidant such oxygen or air, and a catalyst support member for coupling the catalyst in a form of electrode.

The catalyst support member can be made of metallic material such as nickel or nickel alloy. And in consideration of mechanical characteristics, it can be also used together with a binder such as PTFE.

In particular, in case that the catalyst support member is made of metallic material such as nickel or nickel alloy, the electrode catalyst of the present invention with a surface coated with nickel can be stably attached to the catalyst support member, so that when the fuel cell operates, it is prevented from being separated from the catalyst support member.

As the catalyst constituting the electrode is used a hydrogen storage alloy such as a metal hydride (MH).

As the metal hydride (MH), an AB₅-based alloy on the basis of LaNi₅, MnNi₅ (Mn: misch metal: mixture of rare earth metal) and an AB₂-based alloy principally including C14 or C15a laves phase are used. The AB₅-based alloy or AB₂-based alloy or the like is a monoatomic-based alloy in which a portion of La or Ni is substituted with a different element. That is, Zr or Ti is used as an element ‘A’ and Ni, V, Mn, Cr, Al, etc. is used as an element ‘B’.

The catalyst can be made in various forms. Especially, it is preferably implemented in a form such that contacting area of the catalyst with the fuel such as hydrogen is increased. That is, the catalyst can be implemented as fine powders, fine fibers or porous body, etc. As a matter of course, the catalysts are attached to the catalyst support member to form one electrode.

The catalyst used for the electrode of the fuel cell is generally used for the fuel electrode (anode) but also can be used for the oxygen electrode (cathode).

An embodiment of the fuel cell, electrode catalyst and the electrode for the fuel cell in accordance with the present invention will now be described.

### Embodiment

Metal hydride (MH) is used as an electrode catalyst, and MH1 of Zr_{0.9}Ti_{0.1}Cr_{0.55}Fe_{1.45} (wt %: 41.73, 2.44, 14.54, 41.28) and MH2 of Zr_{0.9}Ti_{0.1}Mn_{0.6}V_{0.2}Co_{0.1}N_{1.1} (wt % 40.93: 2.39, 16.46, 5.08, 2.94, 32.2), which are AB₂-based alloys, are used.

The metal hydride in a powder form is put in a solution containing nickel in a certain constant pH, to coat the metal hydride with nickel. That is, a first solution comprising 10 g/CO₃.Ni(OH)₂.4H₂O (nickel carbonate-basic) and 5 g/C₆H₅O₇Na₃.H₂O (Sodium citrate), a second solution comprising 20 g/NaPH₂O₂.H₂O (Sodium hypophosphite monohydrate), 5 g/C₆H₅Na₃.H₂O (Sodium Citrate) and 10 ml/HF, and a third solution for controlling and stabilizing pH are mixed and maintained at a temperature of below 70° C. and pH of 6.5, in which the metal hydride in a powder form is put for 5, 10 or 15 minutes, for performing a nickel coating on the surface of the metal hydride in a powder form.

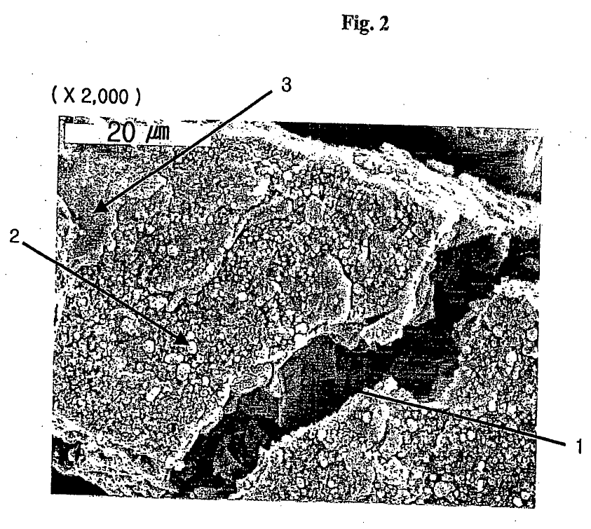

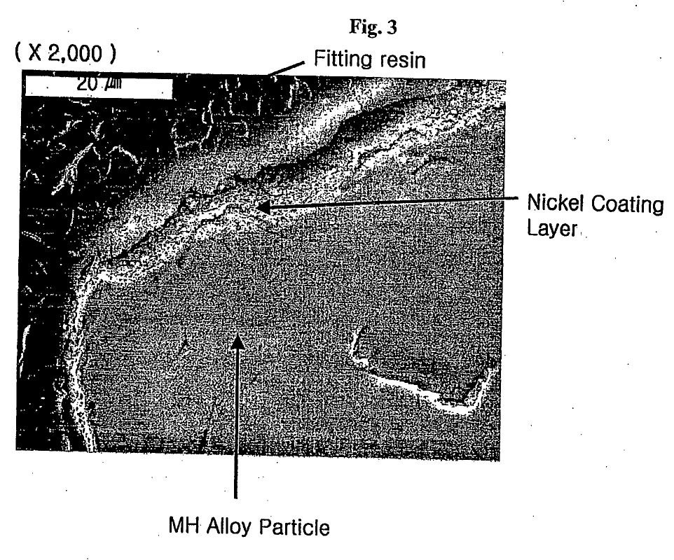

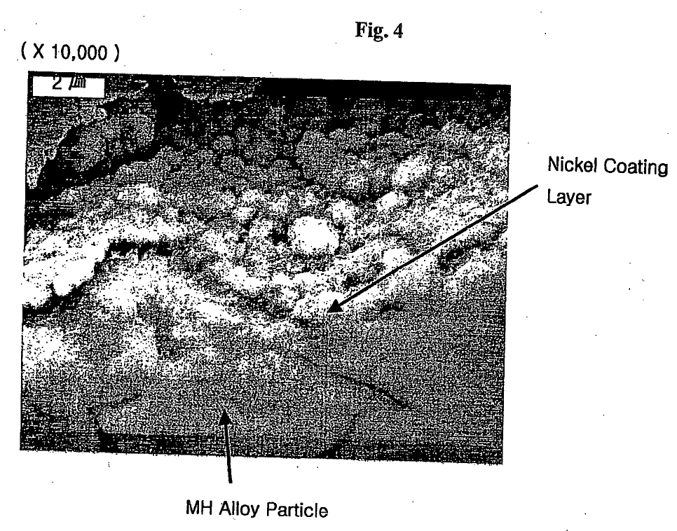

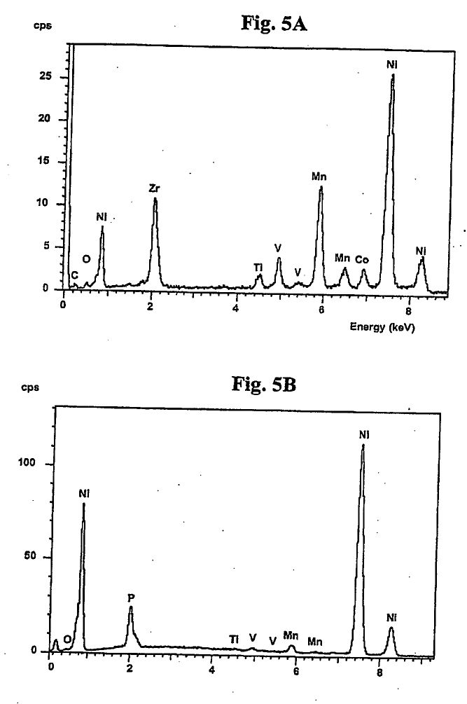

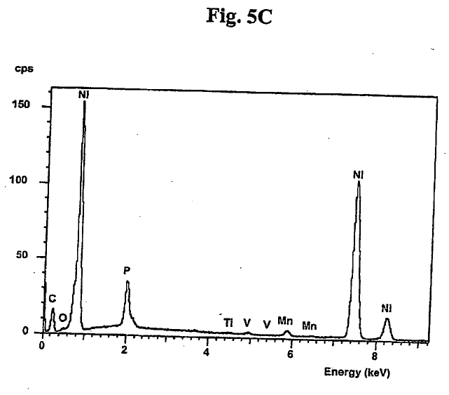

FIGS. 2 to 4 are photographs of an enlarged electrode catalyst after being taken by a scanning electron microscope (SEM) and FIGS. 5A to 5C are graphs obtained by performing an EDS (Energy Dispersive Spectroscopy) for analyzing composition of material, showing the portion 1, 2 and 3 of FIG. 2. The result of nickel coating in accordance with the present invention is as shown in Tables 1, 2 and 3.

TABLE 1

| | Ni | Mn | Zr | Co | V | Ti | Total |
|---|---|---|---|---|---|---|---|
| Weight (%) | 60.48 | 16.05 | 14.75 | 4.15 | 3.16 | 1.42 | 100 |
| Atomic (%) | 62.59 | 17.75 | 9.82 | 4.28 | 3.77 | 1.8 | 100 |

TABLE 2

| | Ni | P | Mn | V | Total |
|---|---|---|---|---|---|
| Weight (%) | 93.18 | 4.68 | 1.67 | 0.47 | 100 |
| Atomic (%) | 89.27 | 8.49 | 1.71 | 0.52 | 100 |

TABLE 3

| | Ni | P | Mn | V | Ti | Total |
|---|---|---|---|---|---|---|
| Weight (%) | 91.1 | 6.92 | 1.48 | 0.38 | 0.12 | 100 |
| Atomic (%) | 85.63 | 12.33 | 1.48 | 0.42 | 0.14 | 100 |

As shown in FIGS. 2 to 4 and Tables 1 to 3, it is noted, that nickel has been coated on the surface of the hydrogen alloy.

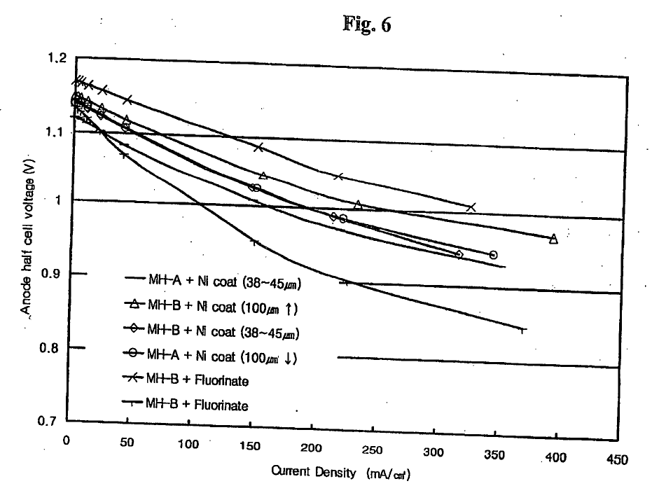

The results of the operations of the fuel cells with the MH1 and MH2 coated with nickel in accordance with the present invention and the fluoride-processed MH2 as disclosed in Japanese Laid Open Publication No. 2002-246039, at a temperature of about 35° C., is as shown in FIG. 6. It is noted that it has a similar performance to a fuel cell using the fluoride-processed MH2 catalyst as an electrode.

As so far described, the fuel cell, the electrode catalyst and the electrode for a fuel cell in accordance with the present invention have an oxidation resistance against fuel supplied to the anode. Thus, even if the fuel cell is used for a long time, it can supply stable power.

In addition, when the electrode catalyst is attached to the catalyst support member made of nickel, it is stably attached to the catalyst support member, so that the life span of the fuel cell is lengthened.

It will be apparent to those skilled in the art that various modifications and variations can be made in the fuel cell, the electrode catalyst and the electrode for a fuel cell the present invention without departing from the spirit or scope of the invention. Thus, it is intended that the present invention cover modifications and variations of this invention provided they come within the scope of the appended claims and their equivalents.

1. A fuel cell comprising:
a fuel electrode made of a hydrogen storage alloy coated with nickel;
an oxygen electrode; and
an electrolyte unit interposed between the fuel electrode and oxygen electrode.

2. The fuel cell of claim 1, wherein the hydrogen storage alloy is metal hydride.

3. The fuel cell of claim 2, wherein the metal hydride is in a powder form.

4. The fuel cell of claim 2 or 3, wherein the metal hydride is AB₂-based.

5. The fuel cell of claim 1, wherein the oxygen electrode is a hydrogen storage alloy coated with nickel.

6. A fuel cell comprising:
a fuel electrode made of a metal hydride coated with nickel;
an oxygen electrode; and
an electrolyte unit interposed between the fuel electrode and the oxygen electrode.

7. An electrode catalyst of an electrode of a fuel cell having a fuel electrode, an oxygen electrode, and an electrolyte unit interposed between the fuel electrode and the oxygen electrode,
wherein the electrode catalyst is made of a hydrogen storage alloy of which a surface is coated with nickel.

8. The catalyst of claim 7, wherein the electrode catalyst has a powder form

9. The catalyst of claim 7, wherein the electrode catalyst has a fine fiber form

10. The catalyst of claim 7, wherein the electrode catalyst forms a porous body.

11. The catalyst of claim 7, wherein the hydrogen storage alloy is a metal hydride.

12. The catalyst of claim 7, wherein the electrode catalyst is attached to a catalyst support member made of nickel or a nickel alloy material.

13. An electrode of a fuel cell, said electrode being made of the catalyst of one of claims 7 and 8.
